(19) United States
(12) Patent Application Publication
(10) Pub. No.: US 2017/0274815 A1
(43) Pub. Date: Sep. 28, 2017

(54) AUTOACTIVE BRAKING LIGHTS

(71) Applicant: GM Global Technology Operations LLC, Detroit, MI (US)

(72) Inventor: IDO ZELMAN, RA'ANANA (IL)

(21) Appl. No.: 15/078,269

(22) Filed: Mar. 23, 2016

(51) Int. Cl. B60Q 1/44

(52) U.S. Cl. CPC B60Q 1/44

(57) ABSTRACT

A product and method for autoactive brake light activation. A host vehicle may be provided with a brake pedal and braking lights. A perception system may be provided with the host vehicle. Whether the perception system provides information indicative of a triggering event may be evaluated. The braking lights may be activated if the perception system indicates a triggering event. Depression of the brake pedal may be monitored.

### TECHNICAL FIELD

The field to which the disclosure generally relates includes automobile braking and automobile sensing ability for active/automated features, and in particular includes automated braking light indication and methods of operating automotive braking lights.

### BACKGROUND

Automobiles have long included illuminating rear indicators for alerting following vehicles when a leading vehicle's brakes have been applied. The indicators are typically automatically illuminated when the driver steps on the brake pedal.

### SUMMARY OF ILLUSTRATIVE VARIATIONS

A number of illustrative variations may involve a product and method for autoactive brake light activation. A host vehicle may be provided with a brake pedal and braking lights. A perception system may be provided with the host vehicle. Whether the perception system provides information indicative of a triggering event may be evaluated. The braking lights may be activated if the perception system indicates a triggering event. Depression of the brake pedal may be monitored.

A number of additional variations may involve a product that may include a vehicle. A perception system may be provided on the vehicle that supplies information on an area surrounding the vehicle. A rear of the vehicle may include at least one braking light for alerting of a brake related activity to an area behind the vehicle. A braking indicator may be provided on the inside of the vehicle and may be visible to a driver of the vehicle. A controller may be provided for determining whether the perception system perceives information indicative that the vehicle may be approaching a braking event. The braking light may be connected with the controller and the braking indicator may be connected with the controller so that the braking light and the braking indicator are activated simultaneously.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a product according to a number of variations.

FIG. 2 is a schematic illustration of a method of using a product according to a number of variations.

FIG. 3 is a schematic illustration of a method of using a product according to a number of variations

FIG. 4 is a schematic illustration of a method of using a product according to a number of variations

FIG. 5 is a schematic illustration of a method of using a product according to a number of variations.

FIG. 6 illustrates a diagram of a method according to a number of variations.

### DETAILED DESCRIPTION OF ILLUSTRATIVE VARIATIONS

The following description of the variations is merely illustrative in nature and is in no way intended to limit the scope of the invention, its application, or uses.

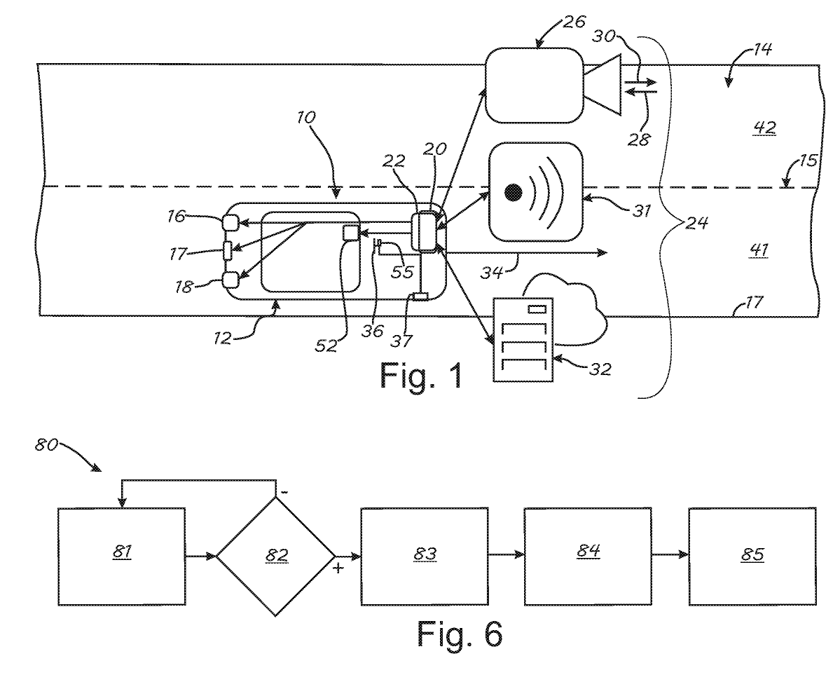

A number of variations a product 10 as illustrated in FIG. 1, may include a host vehicle 12. The host vehicle 12 may be a passenger car, truck, utility vehicle, or another type of vehicle for use on a roadway 14, or for off-road use. In a number of variations, the host vehicle 12 may be any vehicle that includes one or more brake indicator lights 16, 17 18. The host vehicle 12 may be referred to as a “host,” in-that it refers to the vehicle 12, which is the focus of the current description, as opposed to a remote vehicle. The host vehicle 12, may function independently, or it may be a connected vehicle that receives information from a remote source, and/or that may originate a transmission of information. Any received or transmitted information may be in the form of data, or may be converted into data by the host vehicle 12 in a form usable for analyzing or processing purposes.

The host vehicle 12 may include an on-board computer 20 that may include an autoactive braking light (ABL), controller 22. Methods, algorithms, or parts thereof may be implemented in a computer program product of the computer 20 and/or the ABL controller 22, including instructions or calculations carried on a computer readable medium for use by one or more processors to implement one or more method steps or instructions. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program may be executed on one processor or on multiple processors in communication with one another.

In a number of variations, the program(s) may be embodied on computer readable media, which can include one or more storage devices, articles of manufacture, or the like. Illustrative computer readable media may include computer system memory, e.g. random access memory (RAM), read only memory (ROM); semiconductor memory, e.g. erasable, programmable ROM (EPROM), electrically erasable, programmable ROM (EEPROM), flash memory; magnetic or optical disks or tapes; and/or the like. The computer readable medium also may include computer to computer connections, for example, when data may be transferred or provided over a network or another communications connection (either wired, wireless, or a combination thereof). Any combination(s) of the above examples is also included within the scope of the computer-readable media. It is therefore to be understood that methods may be at least partially performed by any electronic articles and/or devices capable of executing instructions corresponding to one or more steps of the disclosed methods.

The product 10 may include a perception system 24 that may include a number of information receiving and transmitting capabilities, and may include information communicating capabilities. These capabilities may include a sensory suite 26 that may transmit signals and or collect information from the environment surrounding the host vehicle 12. The sensory suite 26 may include sensing devices, which may be classified as sensors installed on the host vehicle 12, and may include camera, LIDAR, RADAR, or any means that provides information on the surroundings of the host vehicle 12. The sensory suite 26 may be receptive or perceptive of inputs 28. For example, one type of sensing device in the sensory suite 26 may use received light, such as in camera operation, or may use another tracing mechanism, and may collect information to construct a visual representation of an object or a group of objects according to any of a variety of available techniques. The computer 20 may include logic for object recognition. The sensory suite 26 may include an object detection system that may detect the presence, direction, distance, and/or speed of an object or objects. The object detection system may operate by sending out signals 30 that may be reflected off the object or objects back to the object detection system, which may be received as part of the inputs 28. The object detection system may use radio waves, such as in RADAR operation, may use light waves, such is in LIDAR operation, may use sound waves, such as in ultrasonic operation, or may use an alternative form of operation, or a number of different types. The sensory suite 26 may be configured to detect and understand road geometry of the roadway 14, traffic lights, signs, various types of objects, other vehicles and their behavior, and other environmental conditions. The sensory suite 26 may monitor in any of the forward, rearward or lateral directions relative to the host vehicle 12. For example, a lateral distance from markings 15, 17 may be determined or from other detectable references along the roadway 14.

In a number of variations information receiving and transmitting capabilities of the perception system 24 may include a communication system 31. The communication system 31 may include a transmitter/receiver device, and related hardware and software to transmit and/or receive information through a signal to and/or from any compatible source that may be remote from the host vehicle 12. The communication system 31 may operate using a vehicle-to-vehicle (v2v), communication to exchange information with other nearby vehicles. The communication system 31 may operate using vehicle to infrastructure (v2x), communication to exchange information from public or private infrastructure sources.

In a number of variations, information receiving and transmitting capabilities of the perception system 24 may include a connected vehicle system 32. The connected vehicle system 32 may operate using internet access, such as through a cellular or satellite link, or using another connection to access relevant information, such as in the cloud, or from any other available source. This may include access to a high precision map server. The connected vehicle system 32 may access GPS information for location purposes. The connected vehicle system 32 may access any source that supports static or dynamic information for the roadway 14. The connected vehicle system 32 may access a remote data-server or cloud-based server that may provide information relevant to operation of the host vehicle 12.

The computer 20/ABL controller 22 may be configured to use any relevant source of information that may be available, whether from the perception system 24 or from other sources, and in particular may use sources of information useful in decisions related to braking. Data may be processed and maintained on a server in static or dynamic form and information may be passed to and from the host vehicle 12, such as through a cellular signal. The sources may provide data in different levels of maturity, which may be subjected to further processing, such as object classification, a representation of road geometry, and other results. This may be carried out by algorithms running on the computer 20/ABL controller 22, which may include predictive capabilities. Separately, or in coordination, algorithms may the processed in any of the sensory suite 26 devices, the communication system 31, the connected vehicle system 32, or the remote connected sources.

In a number of variations the sensory suite 26, the communication system 31, and/or the connected vehicle system 32 may communicate with the computer 20, which may execute processes that may exhibit cognitive abilities that a smart vehicle may exhibit. That is, the host vehicle 12, through the computer 20, may exercise the ability to predict or recall that a triggering event may be about to occur, before the actual information provided by the sensing capabilities confirms the event's occurrence. The triggering event is not necessarily initiated, but the environment may supply information indicating the triggering event is about to happen. The computer 20 may correlate information from the sensory suite 26, the communication system 31, and/or the connected vehicle system 32 to produce a representation of the roadway 14 and/or of obstacles in a path of the host vehicle 12. The constructed representation may be used such that any detected obstacles and their movements may be mapped relative to the location and path of the host vehicle 12. The computer 20 may take into consideration the trajectory 34 of the host vehicle 12, thereby providing information for determining triggering events. The trajectory 34 may be determined from the sensory suite 26 and/or a steering position sensor, speed sensor, or other data collection devices on-board, or remote from, the host vehicle 12. For example, information from the connected vehicle system 32 may be incorporated into the trajectory analysis. The computer 20 may be programmed to use the information on the trajectory 34, along with information from the sensory suite 26, the communication system 31, and/or the connected vehicle system 32, to accomplish one or more specific problem solving or reasoning tasks. For example, the program may have an ability to detect and respond to any number of trigger events that may require a driver to change the momentum of the host vehicle 12. This may include a change in direction, speed or both. The computer 20 may use any relevant information from any of the available sources to which the host vehicle 12 may have access.

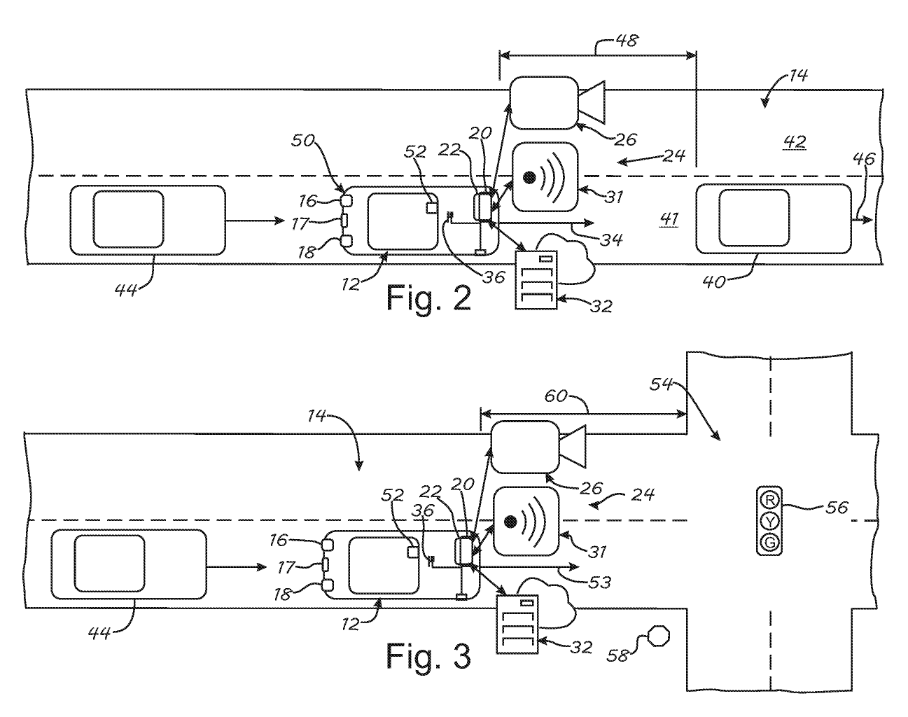

In a number of variations the host vehicle 12 may provide an autoactive braking light control routine when a triggering event is determined via the programming of the ABL controller 22 and/or the computer 20, where the triggering event may be suggestive that the driver of the host vehicle 12 apply the brake pedal 36 and the connected wheel brake 37. The triggering event may be determined by the ABL controller 22 processing information from the vehicle's perception system 24. For example, with reference to FIG. 2, the host vehicle 12 may be traveling on the roadway 14 following a trajectory 34. A preceding vehicle 40 may be traveling on the roadway 14 in front of the host vehicle 12. The preceding vehicle 40 may be traveling in the same lane 41 as the host vehicle. In other variations the preceding vehicle 40 may be traveling in another lane 42, when the roadway 14 includes multiple lanes in the same direction. A following vehicle 44 may be traveling behind the host vehicle 12, and may also be traveling in the lane 41. The host vehicle 12 may be operating under the manual control of the driver and not in an autonomous driving mode. The preceding vehicle 40 may be traveling at a trajectory 46. The trajectory 46 may be determined by the computer 20 using the perception system 24. The ABL controller 22 may determine that the speed at which the preceding vehicle 40 is traveling on the trajectory 46, combined with the distance 48 between the vehicles, equates to a triggering event. In other examples, the ABL controller 22 may determine that the rate of change in speed of the trajectory 46 equates to a triggering event. In such an event, the ABL controller 22 may be programmed to presume that a rapidly reducing change in speed of the preceding vehicle 40 is indicative that the host vehicle is likely to enter an incipient braking situation. The ABL controller 22 may be in communication with the brake indicator lights 16, 17, 18 at the rear 50 of the host vehicle 12, such a through the vehicle's electrical bus and/or wire harness system. The ABL controller 22 may be in communication with a driver autoactive braking indicator 52, such a through the vehicle's electrical bus and/or wire harness system. The autoactive braking indicator 52 may be located in, or near, the instrument panel of the host vehicle 12 and/or may be part of a head up display. The autoactive brake indicator 52 may be located so as to be readily noticed by the driver and may illuminate when initiated by the ABL controller 22. With the determination of a triggering event, the ABL controller 22 may simultaneously activate the brake indicator lights 16, 17, 18 and the autoactive brake indicator 52, such as through simultaneous illumination. The braking indicator lights 16, 17, 18, and the autoactive brake indicator 52 may be activated automatically, preceding an actual pressing on the brake pedal 36 by the driver. That is, both the driver of the host vehicle 12, and the driver of the following vehicle 44 are informed of a possible braking event simultaneously. Braking response time of the driver of the host vehicle 12 does not affect the time in which the driver of the following vehicle 44 is informed. As a result, the response time of the driver of the host vehicle 12 does not affect the time before the driver of the following vehicle 44 is informed of an approaching braking event. The braking indicator lights 16, 17, 18, and the autoactive brake indicator 52 may be activated automatically for a time period that may be equivalent to driver response time. When the driver of the host vehicle 12 presses on the brake pedal 36, the brake pedal sensor 55 may take control of the illumination of the braking indicator lights 16, 17, 18, and the autoactive brake indicator 52 for the driver may be turned off upon depression of the brake pedal. In other words, upon an actual pressing on the brake pedal 36, the driver of the host vehicle 12 is in control, and the braking indicator lights 16, 17, 18 may remain illuminated as long as the driver depresses the brake pedal 36. In a number of variations if the preceding vehicle 40 moves out of a range indicative of the triggering event before the brake pedal 36 is depressed, such as by accelerating or switching to lane 42, the ABL controller 22 may deactivate the braking indicator lights 16, 17, 18, and the autoactive brake indicator 52. Similarly, if the driver of the host vehicle 12 moves it out of the range indicative of the triggering event before the brake pedal 36 is depressed, the ABL controller 22 may deactivate the braking indicator lights 16, 17, 18, and the autoactive brake indicator 52.

In a number of variations as represented in FIG. 3, the host vehicle 12 may be traveling on the roadway 14 following a trajectory 53. The host vehicle 12 may be approaching an intersection 54. The intersection 54 may include a traffic signal 56, or a sign 58, indicating that the host vehicle 12 may face a triggering event. For example, the traffic signal 56 may be a yellow or red light, or the traffic sign 58 may be a stop or yield sign. A following vehicle 44 may be traveling behind the host vehicle 12, and may also be traveling in the lane 41. The host vehicle 12 may be operating under the manual control of the driver and not in an autonomous driving mode. The ABL controller 22 may determine that the trajectory 53 at which the host vehicle 12 is traveling, combined with the distance 60 between the host vehicle and the intersection 54 equates to a triggering event. For example, the ABL controller 22 may determine that the traffic signal 56 is yellow or red and the rate at which the host vehicle 12 is approaching the intersection 54 equates to a triggering event. In such an event, the ABL controller 22 may be programmed to presume that a yellow or red light is indicative that the host vehicle 12 is likely to enter an incipient braking situation. With the determination of a triggering event being made, the ABL controller 22 may simultaneously activate the brake indicator lights 16, 17, 18 and the autoactive brake indicator 52, such as through simultaneous illumination. The braking indicator lights 16, 17, 18, and the autoactive brake indicator 52 may be activated automatically for a time period equivalent to driver response time. When the driver of the host vehicle presses on the brake pedal 36, the brake pedal sensor 55 may take control of the illumination of the braking indicator lights 16, 17, 18, and the autoactive brake indicator 52 for the driver may be turned off upon depression of the brake pedal 36. In a number of variations if the traffic signal turns green prior to depression of the brake pedal 36, the braking indicator lights 16, 17, 18, and the autoactive brake indicator 52 may be deactivated by the ABL controller 22. In other variations the ABL controller 22 may be programmed to presume that a stop or yield sign as the traffic sign 58, combined with the trajectory 53, is indicative that the host vehicle 12 is likely to enter an incipient braking situation, and a determination of a triggering event may be made.

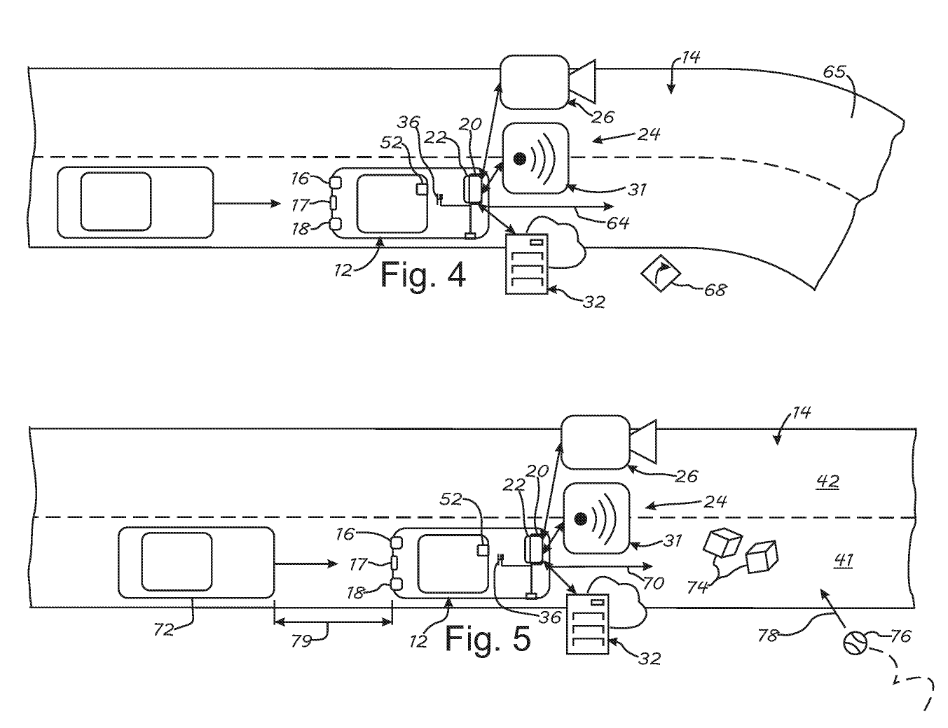

In a number of variations as represented in FIG. 4, the host vehicle 12 may be traveling on the roadway 14 following a trajectory 64. The host vehicle 12 may be operating under the manual control of the driver and not in an autonomous driving mode. The host vehicle 12 may be approaching a curve 65 in the roadway 14. The curve 65, in combination with the trajectory 64 may be determined by the ABL controller 22 to indicate that the host vehicle 12 may face a triggering event. For example, information on the curve 65 may be obtained through the perception system 24 such as from a high precision map server and/or from a traffic sign 68 that may alert of a curve ahead. The ABL controller 22 may determine the curve 65 has a curvature that suggests a slower speed of the host vehicle 12 than that at which it is currently traveling, which may be programmed to be a triggering event. In such an event, the ABL controller 22 may be programmed such as with a lookup table of thresholds for vehicle speeds and roadway curvatures indicative that the host vehicle 12 is likely to enter an incipient braking situation. With the determination of a triggering event being made, the ABL controller 22 may simultaneously activate the brake indicator lights 16, 17, 18 and the autoactive brake indicator 52, such as through simultaneous illumination. The braking indicator lights 16, 17, 18, and the autoactive brake indicator 52 may be activated automatically for a time period equivalent to driver response time. When the driver of the host vehicle presses on the brake pedal 36, the brake pedal sensor 55 may take control of the illumination of the braking indicator lights 16, 17, 18, and the autoactive brake indicator 52 for the driver may be turned off upon depression of the brake pedal 36. In a number of variations if the driver slows the host vehicle 12 below a speed indicative of a threshold for the curvature of the curve 65 prior to depression of the brake pedal 36, the braking indicator lights 16, 17, 18, and the autoactive brake indicator 52 may be deactivated by the ABL controller 22. In addition to road curves, in additional variations the ABL controller 22 may determine the presence of a triggering event in response to precise map service updates on a traffic event that indicates an upcoming brake application.

In a number of variations as represented by FIG. 5, the host vehicle 12 may be traveling on the roadway 14 following a trajectory 70. A following vehicle 72 may be traveling behind the host vehicle 12, and may also be traveling in the lane 41. The host vehicle 12 may be operating under the manual control of the driver and not in an autonomous driving mode. The ABL controller 22 may process information from the perception system 24 and may determine that the trajectory 70 combined with the location of one or more objects 74 equates to a triggering event. The object(s) 74 may for example, be articles such as boxes that may have fallen in the roadway 14, or may be any object including a pedestrian, bicyclist, etc. In such an event, the ABL controller 22 may be programmed to conclude that the presence of the object(s) 74 is indicative that the host vehicle 12 is likely to enter an incipient braking situation. With the determination of a triggering event, the ABL controller 22 may simultaneously activate the brake indicator lights 16, 17, 18 and the autoactive brake indicator 52, such as through simultaneous illumination. The braking indicator lights 16, 17, 18, and the autoactive brake indicator 52 may be activated automatically for a time that may at least be a period equivalent to driver response time. When the driver of the host vehicle presses on the brake pedal 36, the brake pedal sensor 55 may take control of the illumination of the braking indicator lights 16, 17, 18, and the autoactive brake indicator 52 for the driver may be turned off upon depression of the brake pedal. In a number of variations if the driver of the host vehicle 12 moves around the object(s) 74 such as into the lane 42, before the brake pedal 36 is depressed, the ABL controller 22 may deactivate the braking indicator lights 16, 17, 18, and the autoactive brake indicator 52. In a number of variations, the triggering event may be a moving object 76, which may be any animate, or inanimate object. The ABL controller 22 may project a path 78 of the object 76, which may be predicted to enter the trajectory 70, resulting in the triggering event.

In a number of variations the host vehicle 12 may be equipped with a perception system 24 that may include a rearward looking sensor to determine the distance 79 to the following vehicle 44. If distance 79 between following vehicle 44 and the host vehicle 12 is greater than a threshold, or if there is no following vehicle, the ABL controller 22 may be programmed to forego activation of the braking indicator lights 16, 17, 18. In such a case, the autoactive brake indicator 52 may be activated to alert the driver of the host vehicle 12 and may be deactivated upon depression of the brake pedal 36. In a number of variations the ABL controller and/or the computer 20 may activate brakes 37 of the host vehicle automatically. Such operation may support automated driving generally, or automated braking specifically. In automated driving or braking, the braking indicator lights 16, 17, 18, and the brakes of the host vehicle 12 may be activated simultaneously, or the braking indicator lights 16, 17, 18 may be activated in advance.

In a number of variations the methods of autoactive braking light activation as described in relation to the product of FIGS. 1-5, may include the method 80 of FIG. 6. The method 80 may begin at step 81 where the ABL controller 22 may communicate to receive information from the perception system 24, either directly or through the computer 20. This may include information from the sensory suite 26, the communication system 31, and/or the connected vehicle system 32. From step 81, the method 80 may proceed to step 82 where the ABL controller determines whether a triggering event has occurred according to programmed criteria. A triggering event may be any event, or combination of events or occurrences that suggests the driver of the host vehicle 12 is about to depress the brake pedal 36. The level of certainty as to whether the brakes will be applied may be set at a high level. In a number of variations the ABL controller 22 may include a learning routine wherein the level of certainty may be tuned to the driver of the host vehicle 12. If, at step 82, the ABL controller 22 determines that a triggering event has not occurred, the method 80 may return to step 81 and may proceed therefrom. The determination of whether a triggering event has occurred may be conducted on a continuous loop or may be initiated in response to the occurrence of any preprogrammed event, such as an object detection in the path of the host vehicle 12. If at step 82 a determination is made that a triggering event has occurred, the method 80 may proceed to step 83. At step 83 the ABL controller 22 may activate the braking indicator lights 16, 17, 18 and the autoactive brake indicator 52. The activation may be simultaneous. In a number of variations, such as when the host vehicle 12 is operating in an autonomous mode, the ABL controller may activate the vehicle's brakes. From step 83, the method 80 may proceed to step 84 where the brake pedal 36 sensor 55 may be monitored. If a signal is received from the brake pedal sensor 55 that the brake pedal 36 has been depressed by the driver, the method may proceed to step 85. At step 85, the ABL controller 22 may cease sending a signal to activate the braking indicator lights 16, 17, 18 and the autoactive brake indicator 52. The braking indicator lights 16, 17, 18 may be illuminated as long as the brake pedal 36 is depressed. From step 85 the method 80 may be complete and may return to step 81 to begin again. In a number of variations, the method 80 may be modified in a number of ways. For example, at step 83, the system may activate the braking indicator lights 16, 17, 18 when a triggering event has been detected at step 82. Then, when an actual brake pedal 36 application by the driver is monitored at step 84, the system may end the automatic activation of the braking indicator lights 16, 17, 18, and the existing common mechanism (such as brake pedal), controls their illumination. In the event that an actual depression of the brake pedal 36 by the driver is not monitored, the system may end the automatic activation after a set period. For example, a program of the ABL controller 22 may predict a triggering event, quantified with a certainty level. Prediction may activate the braking indicator lights 16, 17, 18 automatically for the set time period such as 2 seconds (for example), and may then end. If during the set time period the ABL controller 22 determines that the certainly level changes, the system may restart counting of the set time period.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve a method for autoactive brake light activation. A host vehicle may be provided with a brake pedal and braking lights. A perception system may be provided with the host vehicle. Whether the perception system provides information indicative of a triggering event may be evaluated. The braking lights may be activated if the perception system indicates a triggering event. Depression of the brake pedal may be monitored.

Variation 2 may include the method of variation 1 and may include providing the host vehicle with an autoactive braking indicator visible to the host vehicle's driver. The braking lights and the autoactive braking indicator may be activated simultaneously, if the perception system indicates the triggering event.

Variation 3 may include the method of variation 2 and may include deactivating the autoactive braking indicator when the brake pedal may be depressed.

Variation 4 may include the method of variation 1 wherein the host vehicle may operate on a roadway. An object detection system capable of detecting an object in the roadway may be provided. A distance from the host vehicle to the object may be determined. A trajectory of the host vehicle may be determined. The trajectory and the distance may be evaluated to determine whether the triggering event has occurred.

Variation 5 may include the method of variation 1 wherein the perception system may be configured and arranged to detect whether a traffic signal in an intersection is red. A distance to the intersection may be determined. A trajectory of the host vehicle may be determined. The trajectory and the distance may be evaluated to determine whether the triggering event has occurred.

Variation 6 may include the method of variation 1 and may include providing a controller in the host vehicle. An object detection system may be connected to the controller. An area around the host vehicle may be evaluated to determine if the object detection system detects an object that indicates a triggering event.

Variation 7 may include the method of variation 1 and may include determining whether the host vehicle has been operated to negate the triggering event prior to a depression of the brake pedal. The braking lights may be deactivated if the triggering event has been negated.

Variation 8 may include the method of variation 1 and may include providing a second vehicle preceding the host vehicle. A trajectory of the second vehicle may be determined. The trajectory to may be compared to the host vehicle. Whether the comparison indicates a triggering event may be determined.

Variation 9 may include the method of variation 1 and may include providing the host vehicle with a rear end. The braking lights may be provided at the rear end of the host vehicle. A braking indicator visible to the host vehicle's driver may be provided. When the triggering event may be indicated, the braking lights and the braking indicator may be activated simultaneously. A driver of the host vehicle may be alerted to depress the brake pedal through the braking indicator.

Variation 10 may include the method of variation 9 and may include providing a brake pedal sensor that determines if the brake pedal may be depressed. The braking indicator may be deactivated when the brake pedal sensor indicates that the brake pedal may be depressed.

Variation 11 may involve a product that may include a vehicle. A perception system may be provided on the vehicle that supplies information on an area surrounding the vehicle. A rear of the vehicle may include at least one braking light for alerting of a brake related activity to an area behind the vehicle. A braking indicator may be provided on the inside of the vehicle and may be visible to a driver of the vehicle. A controller may be provided for determining whether the perception system perceives information indicative that the vehicle may be approaching a braking event. The braking light may be connected with the controller and the braking indicator may be connected with the controller so that the braking light and the braking indicator are activated simultaneously.

Variation 12 includes the product of variation 11 and may include a brake pedal for braking the vehicle through wheel brakes. The wheel brakes may only be applied by the driver through the brake pedal, and not by the controller.

Variation 13 includes the product of variation 11 wherein the vehicle may be adapted to operate on a roadway. A connected vehicle system may be connected to the controller and may provide at least a part of the information to the controller.

Variation 14 may include a method of operating the product of variation 11 and may include providing an object detection system capable of detecting an object in the roadway. A distance from the vehicle to the object may be determined. A trajectory of the vehicle may be determined. The trajectory and the distance may be evaluated to determine whether a triggering event has occurred. The triggering event may be indicative of an approaching application of the brake.

Variation 15 may include the method according to variation 14 and may include providing a second vehicle preceding the vehicle. The trajectory of the second vehicle may be determined. The trajectory may be compared to the vehicle. Whether the comparison indicates a triggering event may be determined.

Variation 16 may include the method according to variation 14 and may include activating the braking lights and the braking indicator simultaneously when the triggering event may be indicated. The driver of the vehicle may be alerted to depress the brake pedal through the braking indicator.

Variation 17 may include the method according to variation 14 and may include providing a brake pedal. A brake pedal sensor may be provided that determines if the brake pedal is depressed. The braking indicator may be activated when the brake pedal sensor indicates that the brake pedal is depressed.

Variation 18 may include the method according to variation 16 and may include determining whether the vehicle has been operated to negate the triggering event prior to a depression of the brake pedal. The braking lights may be deactivated if the triggering event has been negated.

Variation 19 may include a method of operating the product of variation 11 wherein the perception system may be configured and arranged to detect whether a traffic signal in an intersection may be red. A distance to the intersection may be determined. A trajectory of the host vehicle may be determined. The trajectory and the distance may be evaluated to determine whether the triggering event has occurred.

Variation 20 may include a method of operating the product of variation 11 and may include connecting an object detection system to the controller. An area around the vehicle may be evaluated to determine if the object detection system detects an object that indicates a triggering event.

The above description of select variations within the scope of the invention is merely illustrative in nature and, thus, variations or variants thereof are not to be regarded as a departure from the spirit and scope of the invention.

1. A method for autoactive brake light activation comprising: providing a host vehicle with a brake pedal and braking lights; providing a perception system with the host vehicle; evaluating whether the perception system provides information indicative of a triggering event; activating the braking lights if the perception system indicates a triggering event; and monitoring depression of the brake pedal providing the host vehicle with an autoactive braking indicator visible to the host vehicle's driver; and activating the braking lights and the autoactive braking indicator if the perception system indicates the triggering event.

2. The method of claim 1 comprising activating the braking lights and the autoactive braking indicator simultaneously if the perception system indicates the triggering event.

3. The method according to claim 2 comprising deactivating the autoactive braking indicator upon the occurrence of at least one of: the brake pedal is depressed, or a set time period has expired.

4. (canceled)

5. The method according to claim 1 wherein the perception system is configured and arranged to detect whether a traffic signal in an intersection is red; determining a distance to the intersection; determining a trajectory of the host vehicle, and evaluating the trajectory and the distance to determine whether the triggering event has occurred.

6. The method according to claim 1 comprising providing a controller in the host vehicle; connecting an object detection system to the controller; and evaluating an area around the host vehicle to determine if the object detection system detects an object that indicates a triggering event.

7. The method according to claim 1 comprising determining whether the host vehicle has been operated to negate the triggering event prior to a depression of the brake pedal; and deactivating the braking lights if the triggering event has been negated.

8. The method according to claim 1 comprising providing a second vehicle preceding the host vehicle; determining a trajectory of the second vehicle; comparing the trajectory to the host vehicle; determining whether the comparison indicates a triggering event.

9. The method according to claim 1 comprising providing the host vehicle with a rear end; providing the braking lights at the rear end of the host vehicle; providing an braking indicator visible to the host vehicle's driver; when the triggering event is indicated, activating the braking lights and the braking indicator simultaneously; and alerting a driver of the host vehicle to depress the brake pedal through the braking indicator.

10. The method according to claim 9 comprising providing a brake pedal sensor that determines if the brake pedal is depressed; and deactivating the braking indicator when the brake pedal sensor indicates that the brake pedal is depressed.

11. A product comprising a vehicle, a perception system on the vehicle that supplies information on an area surrounding the vehicle, a rear of the vehicle including at least one braking light for alerting of a brake related activity to an area behind the vehicle, a braking indicator on the inside of the vehicle and visible to a driver of the vehicle, and a controller for determining whether the perception system perceives information indicative that the vehicle is approaching a braking event, the braking light connected with the controller and the braking indicator connected with the controller so that the braking light and the braking indicator are activated simultaneously.

12. The product according to claim 11 comprising a brake pedal for braking the vehicle through wheel brakes, wherein the wheel brakes are only applied by the driver through the brake pedal, and not by the controller.

13. The product according to claim 11 wherein the vehicle is adapted to operate on a roadway and comprising a connected vehicle system connected to the controller and providing at least a part of the information to the controller.

14. A method of operating the product of claim 11 comprising providing an object detection system capable of detecting an object in the roadway; determining a distance from the vehicle to the object; determining a trajectory of the vehicle, and evaluating the trajectory and the distance to determine whether a triggering event has occurred, wherein the triggering event is indicative of an approaching application of the brake.

15. The method according to claim 14 comprising providing a second vehicle preceding the vehicle; determining a trajectory of the second vehicle; comparing the trajectory to the vehicle; determining whether the comparison indicates a triggering event.

16. The method according to claim 14 comprising activating the braking lights and the braking indicator simultaneously when the triggering event is indicated; and alerting the driver of the vehicle to depress the brake pedal through the braking indicator.

17. The method according to claim 14 comprising providing a brake pedal; providing a brake pedal sensor that determines if the brake pedal is depressed; and deactivating the braking indicator when the brake pedal sensor indicates that the brake pedal is depressed.

18. The method according to claim 16 comprising determining whether the vehicle has been operated to negate the triggering event prior to a depression of the brake pedal; and deactivating the braking lights if the triggering event has been negated.

19. A method of operating the product of claim 11 wherein the perception system is configured and arranged to detect whether a traffic signal in an intersection is red; and comprising determining a distance to the intersection; determining a trajectory of the host vehicle, and evaluating the trajectory and the distance to determine whether the triggering event has occurred.

20. A method of operating the product of claim 11 comprising connecting an object detection system to the controller; and evaluating an area around the vehicle to determine if the object detection system detects an object that indicates a triggering event.
